(19) United States
(12) Patent Application Publication
(10) Pub. No.: US 2025/0392339 A1
(43) Pub. Date: Dec. 25, 2025

(54) WATERPROOF PHONE CASE WITH EASILY DETACHABLE PANEL

(71) Applicant: Dongguan Shenhai Sports Goods Co., Ltd., Dongguan (CN)

(72) Inventor: Zhidong Wu, Dongguan (CN)

(73) Assignee: Dongguan Shenhai Sports Goods Co., Ltd., Dongguan (CN)

(21) Appl. No.: 19/207,510

(22) Filed: May 14, 2025

(30) Foreign Application Priority Data
Jun. 19, 2024 (CN) 202410795584.X

(51) Int. Cl. H04B 1/3888

(52) U.S. Cl. CPC H04B 1/3888

(57) ABSTRACT

A waterproof phone case with easily detachable panel is provided, including a connecting ring, a fixed inner ring, and a top cover. The fixed inner ring is clamped to an inner side of the connecting ring, and the top cover is clamped to an inner side of the connecting ring. A resilient clip is further provided within the waterproof phone case, which is made of elastic material and one end of the resilient clip away from the connecting ring can be moved freely. Both ends of the resilient clip are moved away from each other by using the spring provided within the resilient clip, causing the one end of the resilient clip away from the connecting ring to move towards the inside of the connecting ring, and subjecting pressure to one side of the mobile phone.

### CROSS REFERENCE TO RELATED APPLICATION

This application claims priority to Chinese Patent Application No. CN 202410795584.X, entitled “waterproof phone case with easily detachable panel”, filed on Jun. 19, 2024, which is hereby incorporated by reference in its entirety.

### TECHNICAL FIELD

The present disclosure relates to the technical field of waterproof phone cases, and in particular to a waterproof phone case with easily detachable panel.

### BACKGROUND

A waterproof phone case is a device that protects the phone from water, dust, and other environmental factors. The waterproof phone case is usually made of sturdy plastic or polycarbonate material, providing excellent physical protection and suitable for outdoor exploration, hiking, and other activities.

Chinese patent publication CN 109700152B discloses a waterproof phone case, including a cuboid-shaped case body, a first window is opened on an upper surface of the phone case, a first transparent film is fixedly sealed at the first window, and the first transparent film is used to be set facing a touch screen on the front of the phone. One end of the case body is provided with a port having a rectangular cross-section, the port is provided with an end cover, one end of the end cover is rotatably connected to the case body, another end of the end cover is fastened to the case body through a snap-fit structure, and the end cover is fixedly provided with an elastic sealing plug inside for sealing the port. When the snap-fit structure fastens the end cover and the case body together, the end cover compresses and fixes the elastic sealing plug at the port. Due to the case body has a certain thickness, and its edges are smooth and not sharp, so that the edges of the case body will not cut the user's skin during use. After the end cover and the case body are fastened together through the snap-fit structure, the end cover compresses and fixes the elastic sealing plug at the port, so that the elastic sealing plug seals the port and prevents water from entering the case body from the port, thus protecting the phone case from being soaked by water.

Chinese patent publication CN 209796301U discloses another waterproof phone case, including a case body, a first window is opened on an upper surface of the case body, a transparent film is fixedly sealed at the first window. One end of the case body is provided with a port having a rectangular cross-section, the port is provided with an end cover, one end of the end cover is rotatably connected to the case body, another end of the end cover is fastened to the case body through a snap-fit structure, and the end cover is fixedly provided with an elastic sealing plug inside for sealing the port. Two edges of the case body along a length direction each is respectively provided with a first through hole for inserting a strap into therein. Due to the case body has a certain thickness, and its edges are smooth and not sharp, so that the edges of the case body will not cut the user's skin during use. After the end cover and the case body are fastened together through the snap-fit structure, the end cover compresses and fixes the elastic sealing plug at the port, so that the clastic sealing plug seals the port and prevents water from entering the case body from the port, thus protecting the case body from being soaked by water. By inserting the strap into the first through hole, the phone may be secured to the user's arm, making it easier for the user to carry the waterproof phone case.

In the above technical solutions, the waterproof phone case is generally improved by optimizing its sealing structure to enhance the waterproof effect. In existing technologies, waterproof phone cases are mainly divided into two categories: hard ones and soft ones. Hard waterproof phone cases are mostly customized styles, usually only suitable for one specific model, and their protective performance is specific and targeted. Soft waterproof phone cases are mostly made of soft plastic materials, which have good adaptability to various mobile phone models and may adapt to different types of mobile phones. However, the soft waterproof phone cases are relatively fragile and easy to break, and it is difficult to provide effective protection for the phone placed therein when subjected to external impacts.

### SUMMARY

The present disclosure aims to provide a waterproof phone case with easily detachable panel to address the following problems raised in the background: the hard waterproof phone cases are mostly customized styles, usually only suitable for the specific model, and their protective performance is specific and targeted; and the soft waterproof phone cases are mostly made of soft plastic materials and may adapt to different types of mobile phones, however the soft waterproof phone cases are relatively fragile and easy to break, and it is difficult to provide effective protection for the phone placed therein when subjected to external impacts.

To achieve the above objectives, the present disclosure adopts the following technical solutions. In some embodiments of the present disclosure, a waterproof phone case with easily detachable panel is provided, which includes a connecting ring, a fixed inner ring, and a top cover. Herein the fixed inner ring is clamped to an inner side of the connecting ring, and the top cover is clamped to an inner side of the connecting ring.

Herein a performed groove is provided on one side of an external upper end of the connecting ring, and the performed groove is configured to form a notch at a connection between the top cover and the connecting ring when the top cover and the connecting ring are fitted together. A resilient clip is fixedly provided within the fixed inner ring, and the resilient clip is configured in a V-shaped structure, one side of the resilient clip is fixedly connected to an inner side of the fixed inner ring, one inner side of the resilient clip away from the connecting ring is internally fixed with a positioning column, a spring is fixedly provided between two separated ends of the resilient clip, and the spring is located on a periphery of the positioning column. A mobile phone is placed within the fixed inner ring, and one side of the mobile phone is in contact with the resilient clip.

In some preferred embodiments of the present disclosure, an annular scaling ring distributed in a circular shape is fixedly provided on a connection between the connecting ring and the fixed inner ring with the top cover, both sides of the annular sealing ring are provided with V-shaped grooves, the inner side of the connecting ring is fixedly provided with a mounting strap arranged in a circular distribution, the mounting strap is internally provided with connecting slots distributed in a circular equidistance, the fixed inner ring is internally provided with fasteners arranged in the circular equidistance, the fasteners are slidably connected into the connecting slots, the top cover is internally provided with slots arranged in the circular equidistance, and the slots are engaged with the fasteners.

In some preferred embodiments of the present disclosure, the connecting ring and the annular sealing ring are made of elastic material, an inner side of the top cover is adhered with the mounting strap to form a whole, and the inner side of top cover is fixedly provided with a transparent film.

In some preferred embodiments of the present disclosure, the V-shaped grooves are arranged in the circular distribution along the annular sealing ring, and both sides of the V-shaped grooves are respectively clamped inside the fixed inner ring and the top cover to form a sealing structure.

In some preferred embodiments of the present disclosure, both sides of the connecting ring is fixedly provided with a plurality of pressed blocks equally spaced, the fixed inner ring is internally provided with a plurality of sliding grooves equally spaced, and the pressed blocks corresponds one-to-one with the sliding grooves.

In some preferred embodiments of the present disclosure, the sliding grooves are internally provided with embedded buttons for sliding, outer sides of the embedded buttons are clamped with the pressed blocks, and the embedded buttons are in contact with the one side of the mobile phone.

In some preferred embodiments of the present disclosure, a top and a bottom of the connecting ring each is provided with a mounting groove, the mounting groove provided on the top of the connecting ring is internally clamped with a sealing plug, and the mounting groove provided on the bottom of the connecting ring is internally clamped with a quick-release plug.

In some preferred embodiments of the present disclosure, the quick-release plug is configured as a two-stage structure, and one end of the quick-release plug is connected into the connecting ring and the fixed inner ring.

In some preferred embodiments of the present disclosure, a rear side of the fixed inner ring is fixedly provided with a rear cover extending to a rear side of the connecting ring, and the rear cover is fixedly provided internally with four symmetrically distributed suction cups extending into the connecting ring.

In some preferred embodiments of the present disclosure, a rear side of the rear cover is provided with a protrusion extending to the rear side of the connecting ring, an interior of the protrusion is provided with the transparent film, and the interior of the protrusion is configured to receive a camera module arranged on a back of the mobile phone.

Compared with the existing technologies, the waterproof phone case with easily detachable panel of the present disclosure has at least the following beneficial effects.

The waterproof phone case with easily detachable panel of the present disclosure, by setting the resilient clip, which is made of elastic material and can move freely on the side away from the connecting ring. Both ends of the resilient clip are moved away from each other by using the spring provided within the resilient clip, causing one end of the resilient clip away from the connecting ring to move towards the inside of the connecting ring, and subjecting pressure to one side of the mobile phone. Thus, by utilizing the clastic deformation of the spring to push the mobile phone into contact with the inside of the fixed inner ring, allowing the spring can drive phones of different sizes to be fixed inside the fixed inner ring, thereby the phones of different models and sizes to be protected by using the waterproof phone case of the present disclosure.

Moreover, the fixed inner ring is fixedly connected inside the connecting ring, and the top cover is engaged with the fasteners through the slots, so that the top cover and the mounting strap are connected to each other, and the top cover, the connecting ring and the fixed inner ring are connected to each other. At this time, the annular sealing ring is located at the connection between the connecting ring, the fixed inner ring and the top cover. The V-shaped grooves formed on the protrusions on the both sides of the annular sealing ring are engaged with each other between the fixed inner ring, the connecting ring, and the top cover, and connected to each other between the top cover, the connecting ring and the fixed inner ring. This allows the top cover, the connecting ring, and the fixed inner ring to subject pressure to both sides of the annular sealing ring, thereby achieving multiple waterproof scaling effects after pressurization.

Furthermore, the connecting ring, the fixed inner ring and the top cover are interconnected to each other to form a cavity, and the mobile phone is placed inside the cavity. The pressed blocks are provided on the outer side of the connecting ring corresponding to the button positions of the mobile phone. Pressing the pressed blocks to subject pressure on the embedded buttons, driving the embedded buttons to slide inside the sliding buttons. By pressing the buttons on one side of the mobile phone through the embedded buttons, the buttons on the side of the mobile phone can be operated. Protruding edges of the embedded buttons can be fixed on the outside of the cavity, making it easy to disassemble and assemble. The embedded buttons can be replaced and matched according to different models of phones.

Furthermore, when the top cover and the connecting ring are attached to each other, the outer transparent film is fixed to the front of the waterproof phone case through the top cover. When the front of the waterproof phone case is impacted, the outer transparent film is the first to bear the impact. When the outer transparent film is damaged, pressure can be applied to the edge of the top cover through the performed groove. By driving the top cover to separate the slot from the fasteners, the top cover can be removed from the waterproof phone case, thereby achieving quick disassembly and installation of the top cover.

Furthermore, the suction cups are symmetrically distributed on the inner side of the rear cover, when the mobile phone is placed in the cavity formed by the interconnection between the connecting ring, the fixed inner ring and the top cover, the back of the mobile phone will come into contact with the suction cups. At this time, the suction cups will adhere to the back of the mobile phone, thereby fixing the mobile phone in the cavity formed by the interconnection between the connecting ring, the fixed inner ring and the top cover, preventing the mobile phone from moving inside and causing damage.

### BRIEF DESCRIPTION OF THE DRAWINGS

FIG. 1 shows a structural perspective view of a waterproof phone case with easily detachable panel in accordance with some embodiments of the present disclosure.

FIG. 2 shows an exploded view of the waterproof phone case with easily detachable panel in accordance with some embodiments of the present disclosure.

FIG. 3 shows a structural schematic diagram of a connecting ring in accordance with some embodiments of the present disclosure.

FIG. 4 shows a structural schematic diagram of an annular sealing ring in accordance with some embodiments of the present disclosure.

FIG. 5 shows a structural schematic diagram after placing a mobile phone into the waterproof phone case with easily detachable panel in accordance with some embodiments of the present disclosure.

FIG. 6 shows a structural schematic diagram of a resilient clip in accordance with some embodiments of the present disclosure.

FIG. 7 shows a structural schematic diagram of a top cover in accordance with some embodiments of the present disclosure.

FIG. 8 shows a structural schematic diagram of a mounting groove in accordance with some embodiments of the present disclosure.

FIG. 9 shows a structural schematic diagram of a quick-release plug in accordance with some embodiments of the present disclosure.

FIG. 10 shows a sectional structure schematic diagram of a fixed inner ring in accordance with some embodiments of the present disclosure.

In the drawings, reference signs are as follows. 1. Connecting ring, 2. Fixed inner ring, 3. Top cover, 4. Annular sealing ring, 5. Mobile phone, 6. Resilient clip, 7. Positioning column, 8. Spring, 9. Mounting strap, 10. Connecting slot, 11. Fastener, 12. Slot, 13. V-shaped groove, 14. Pressed block, 15. Sliding groove, 16. Embedded button, 17. Performed groove, 18. Mounting groove, 19. Scaling plug, 20. Quick-release plug, 21. Rear cover, 22. Suction cup.

### DETAILED DESCRIPTION OF THE EMBODIMENTS

The technical solutions in the embodiments of the present disclosure will be clearly and completely described below in conjunction with the accompanying drawings. Obviously, the described embodiments are only a part of the embodiments of the present disclosure, and not all of them. Based on the embodiments of the present disclosure, all other embodiments obtained by one of ordinary skill in the art without creative labor shall fall within the scope of protection of the present invention.

### Embodiments

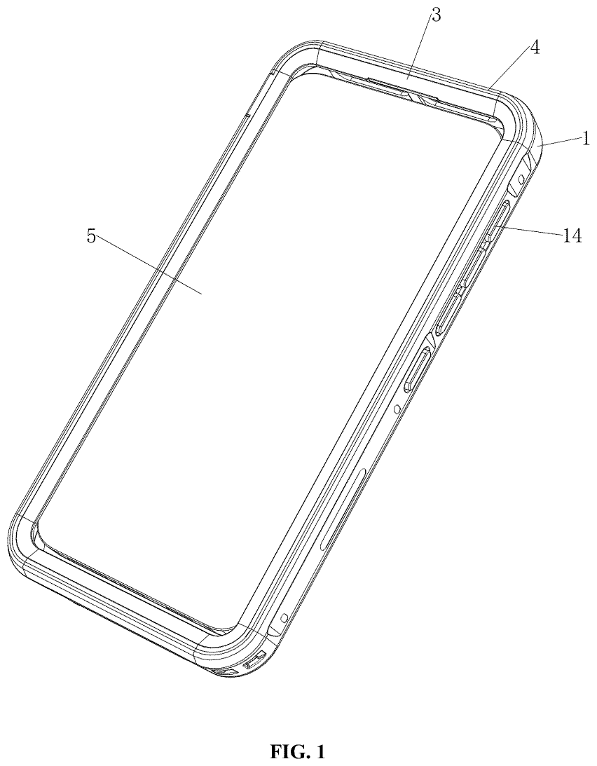

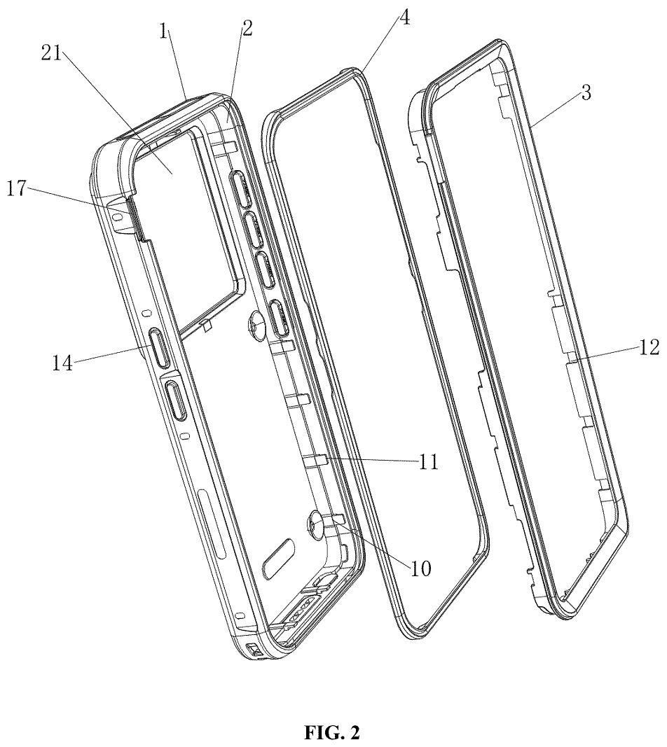

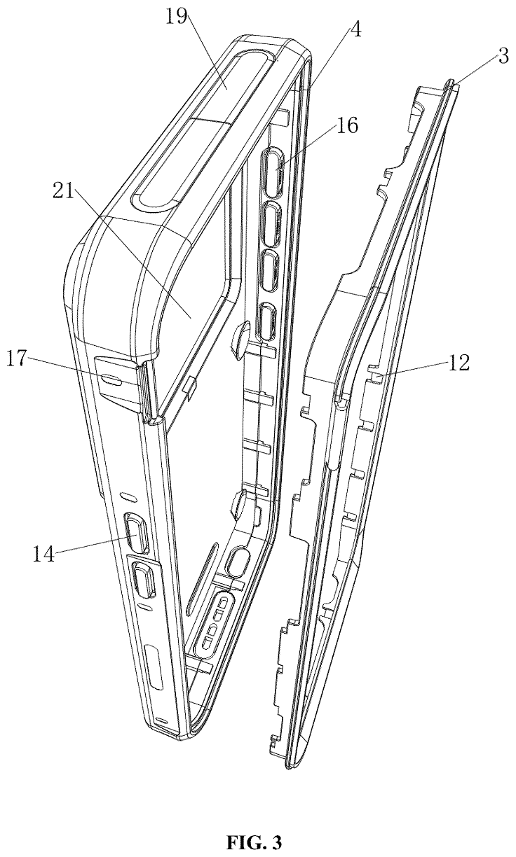

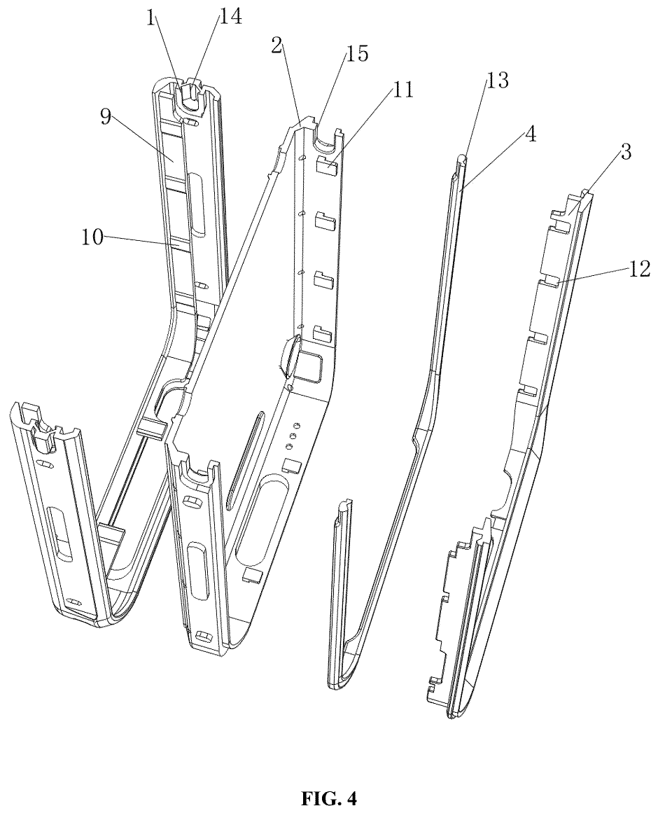

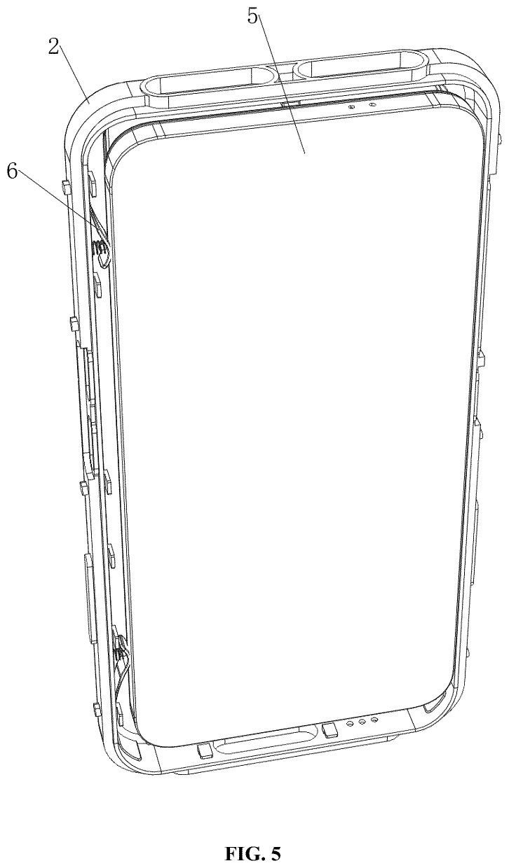

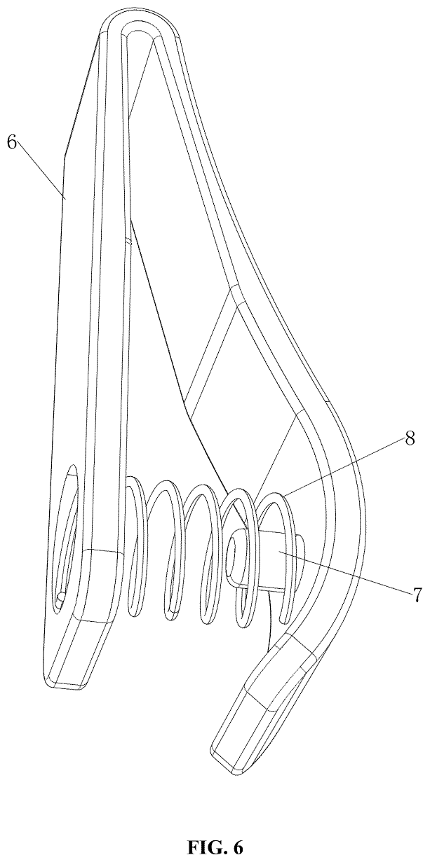

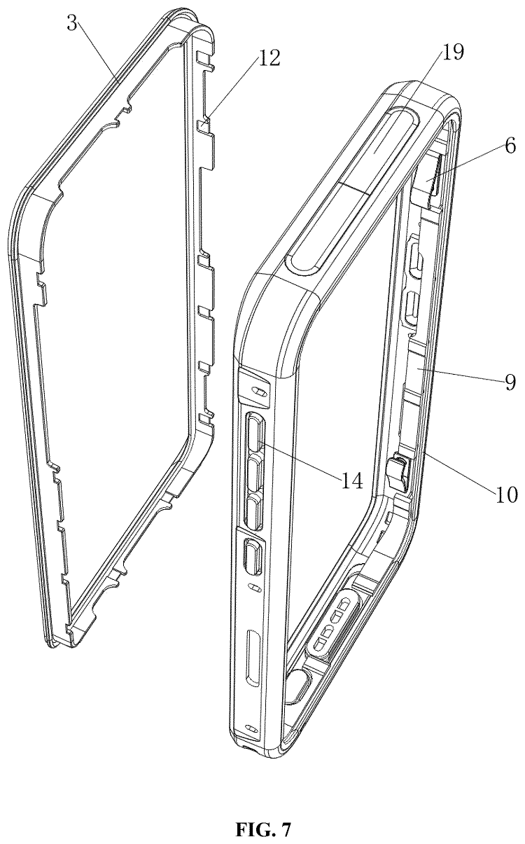

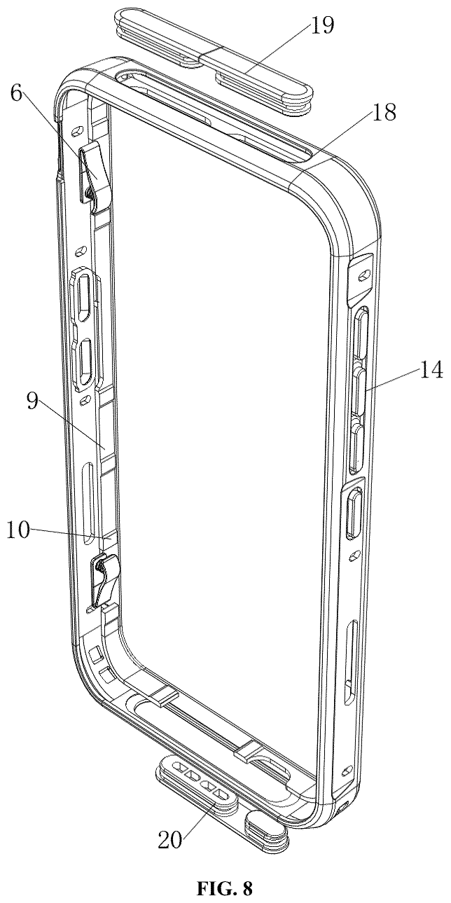

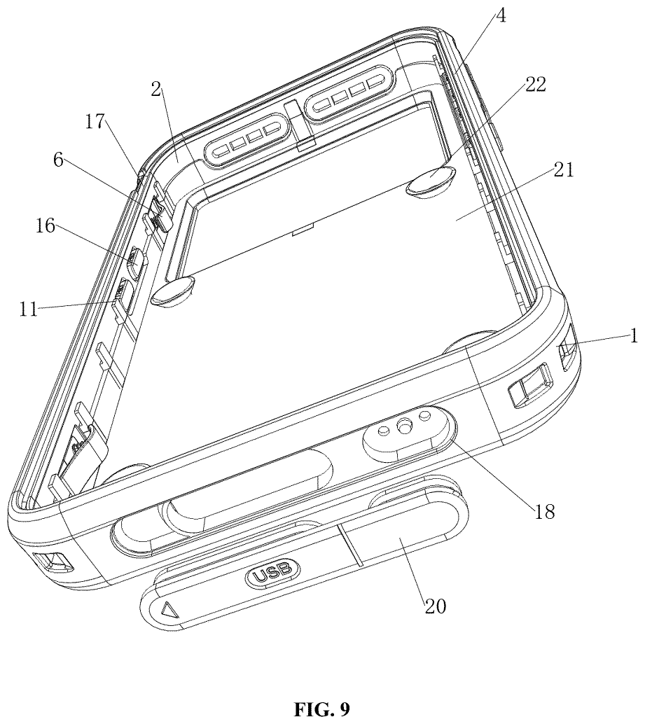

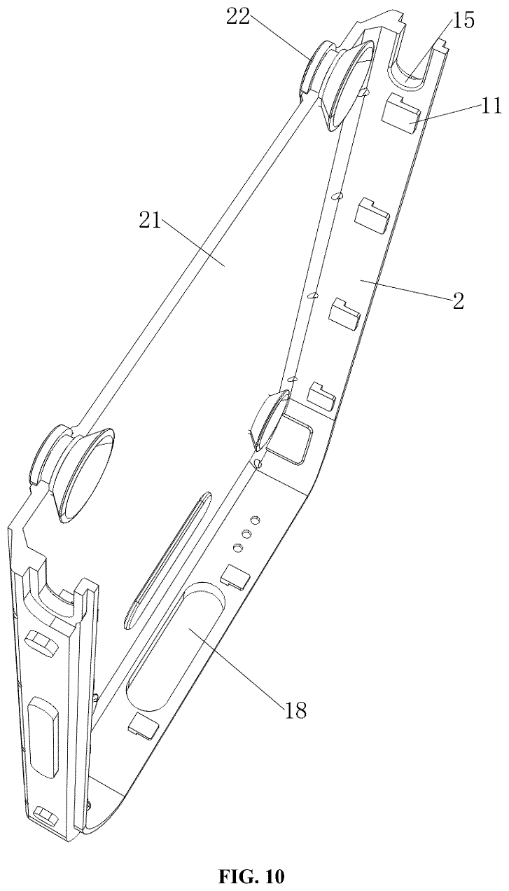

Referring to FIG. 1 to FIG. 10, the present disclosure will provide the following technical solutions.

In some embodiments of the present disclosure, a waterproof phone case with easily detachable panel is provided, including a connecting ring 1, a fixed inner ring 2, and a top cover 3. Herein the fixed inner ring 2 is clamped to an inner side of the connecting ring 1, and the top cover 3 is clamped to an inner side of the connecting ring 1.

A performed groove 17 is provided on one side of an external upper end of the connecting ring 1, and the performed groove 17 is configured to form a notch at a connection between the top cover 3 and the connecting ring 1 when the top cover 3 and the connecting ring 1 are fitted together. A resilient clip 6 is fixedly provided within the fixed inner ring 2, and the resilient clip 6 is configured in a V-shaped structure, one side of the resilient clip 6 is fixedly connected to an inner side of the fixed inner ring 2, another side of the resilient clip 6 away from the connecting ring 1 is internally fixed with a positioning column 7, a spring 8 is fixedly provided between two separated ends of the resilient clip 6, and the spring 8 is located on a periphery of the positioning column 7. A mobile phone 5 is placed within the fixed inner ring 2, and one side of the mobile phone 5 is in contact with the resilient clip 6.

An annular sealing ring 4 distributed in a circular shape is fixedly provided on a connection between the connecting ring 1 and the fixed inner ring 2 with the top cover 3, both sides of the annular sealing ring 4 are provided with V-shaped grooves 13, the inner side of the connecting ring 1 is fixedly provided with a mounting strap 9 arranged in a circular distribution, the mounting strap 9 is internally provided with connecting slots 10 distributed in a circular equidistance, the fixed inner ring 2 is internally provided with fasteners 11 arranged in the circular equidistance, the fasteners 11 are slidably connected into the connecting slots 10, the top cover 3 is internally provided with slots 12 arranged in the circular equidistance, and the slots 12 are engaged with the fasteners 11.

The connecting ring 1 and the annular sealing ring 4 are made of elastic material, an inner side of the top cover 3 is adhered with the mounting strap 9 to form a whole, and the inner side of top cover 3 is fixedly provided with a transparent film.

The V-shaped grooves 13 are arranged in the circular distribution along the annular sealing ring 4, and both sides of the V-shaped grooves 13 are respectively clamped inside the fixed inner ring 2 and the top cover 3 to form a sealing structure.

Both sides of the connecting ring 1 is fixedly provided with a plurality of pressed blocks 14 equally spaced, the fixed inner ring 2 is internally provided with a plurality of sliding grooves 15 equally spaced, and the pressed blocks 14 corresponds one-to-one with the sliding grooves 15.

The sliding grooves 15 are internally provided with embedded buttons 16 for sliding, outer sides of the embedded buttons 16 are clamped with the pressed blocks 14, and the embedded buttons 16 are in contact with the one side of the mobile phone 5.

A top and a bottom of the connecting ring 1 each is provided with a mounting groove 18, the mounting groove 18 provided on the top of the connecting ring 1 is internally clamped with a sealing plug 19, and the mounting groove 18 provided on the bottom of the connecting ring 1 is internally clamped with a quick-release plug 20.

The quick-release plug 20 is configured as a two-stage structure, and one end of the quick-release plug 20 is connected into the connecting ring 1 and the fixed inner ring 2.

A rear side of the fixed inner ring 2 is fixedly provided with a rear cover 21 extending to a rear side of the connecting ring 21, and the rear cover 21 is fixedly provided internally with four symmetrically distributed suction cups 22 extending into the connecting ring 1.

A rear side of the rear cover 21 is provided with a protrusion extending to the rear side of the connecting ring 1, an interior of the protrusion is provided with the transparent film, and the interior of the protrusion is configured to receive a camera module arranged on a back of the mobile phone 5.

### Other Embodiments

Based on the above embodiments, the specific operating principle of the waterproof phone case with easily detachable panel of the present disclosure is as follows.

The waterproof phone case with easily detachable panel of the present disclosure, by setting the resilient clip 6, which is made of elastic material and can move freely on the side away from the connecting ring 1. Both ends of the resilient clip 6 are moved away from each other by using the spring 8 provided within the resilient clip 6, causing one end of the resilient clip 6 away from the connecting ring I to move towards the inside of the connecting ring 1, and subjecting pressure to one side of the mobile phone 5. Thus, by utilizing the elastic deformation of the spring 8 to push the mobile phone 5 into contact with the inside of the fixed inner ring 2, allowing the spring 8 can drive phones of different sizes to be fixed inside the fixed inner ring 2, thereby the phones of different models and sizes to be protected by using the waterproof phone case of the present disclosure.

Moreover, the fixed inner ring 2 is fixedly connected inside the connecting ring 1, and the top cover 3 is engaged with the fasteners 11 through the slots 12, so that the top cover 3 and the mounting strap 9 are connected to each other, and the top cover 3, the connecting ring 1 and the fixed inner ring 2 are connected to each other. At this time, the annular sealing ring 4 is located at the connection between the connecting ring 1, the fixed inner ring 2 and the top cover 3. The V-shaped grooves 13 formed on the protrusions on the both sides of the annular scaling ring 4 are engaged with each other between the fixed inner ring 2, the connecting ring 1, and the top cover 3, and connected to each other between the top cover 3, the connecting ring 1 and the fixed inner ring 2. This allows the top cover 3, the connecting ring 1, and the fixed inner ring 2 to subject pressure to both sides of the annular sealing ring 4, thereby achieving multiple waterproof scaling effects after pressurization.

Furthermore, the connecting ring 1, the fixed inner ring 2 and the top cover 3 are interconnected to each other to form a cavity, and the mobile phone 5 is placed inside the cavity. The pressed blocks 14 are provided on the outer side of the connecting ring 1 corresponding to the button positions of the mobile phone 5. Pressing the pressed blocks 14 to subject pressure on the embedded buttons 16, driving the embedded buttons 16 to slide inside the sliding buttons 15. By pressing the buttons on one side of the mobile phone 5 through the embedded buttons 16, the buttons on the side of the mobile phone 5 can be operated. Protruding edges of the embedded buttons 16 can be fixed on the outside of the cavity, making it easy to disassemble and assemble. The embedded buttons 16 can be replaced and matched according to different models of phones.

Furthermore, when the top cover 3 and the connecting ring I are attached to each other, the outer transparent film is fixed to the front of the waterproof phone case through the top cover 3. When the front of the waterproof phone case is impacted, the outer transparent film is the first to bear the impact. When the outer transparent film is damaged, pressure can be applied to the edge of the top cover 3 through the performed groove 17. By driving the top cover 3 to separate the slot 12 from the fasteners 11, the top cover 3 can be removed from the waterproof phone case, thereby achieving quick disassembly and installation of the top cover 3.

Furthermore, the suction cups 22 are symmetrically distributed on the inner side of the rear cover 21, when the mobile phone 5 is placed in the cavity formed by the interconnection between the connecting ring 1, the fixed inner ring 2 and the top cover 3, the back of the mobile phone 5 will come into contact with the suction cups 22. At this time, the suction cups 22 will adhere to the back of the mobile phone 5, thereby fixing the mobile phone 5 in the cavity formed by the interconnection between the connecting ring 1, the fixed inner ring 2 and the top cover 3, preventing the mobile phone 5 from moving inside and causing damage.

In the description of the present disclosure, it should be noted that unless otherwise specified and limited, the term “connection”, “connect” should be broadly understood, for example, it can be fixed connections, detachable connections, or integral connections. Alternatively, it can be a mechanical connection or an electrical connection, or it can be directly connected or indirectly connected through an intermediate medium. For one of ordinary skill in the art, the specific meanings of the terms in the present disclosure can be understood in specific situations.

Although the present disclosure has been described in detail with reference to the above embodiments, it is still possible for one of ordinary skill in the art to modify the technical solutions described in the above embodiments, or to make equivalent substitutions for some of the technical features. Any modifications, equivalent substitutions, improvements, etc. made within the concept and principles of the present disclosure should be included within the scope of protection of the present invention.

What is claimed is:

1. A waterproof phone case with easily detachable panel, comprising a connecting ring, a fixed inner ring, and a top cover; wherein the fixed inner ring is clamped to an inner side of the connecting ring, and the top cover is clamped to an inner side of the connecting ring;
wherein a performed groove is provided on one side of an external upper end of the connecting ring, and the performed groove is configured to form a notch at a connection between the top cover and the connecting ring when the top cover and the connecting ring are fitted together;
wherein a resilient clip is fixedly provided within the fixed inner ring, and the resilient clip is configured in a V-shaped structure, one side of the resilient clip is fixedly connected to an inner side of the fixed inner ring, another side of the resilient clip away from the connecting ring is internally fixed with a positioning column, a spring is fixedly provided between two separated ends of the resilient clip, and the spring is located on a periphery of the positioning column;
wherein a mobile phone is placed within the fixed inner ring, and one side of the mobile phone is in contact with the resilient clip;
wherein an annular sealing ring is fixedly provided on a connection between the connecting ring and the fixed inner ring with the top cover, both sides of the annular sealing ring are provided with V-shaped grooves, the inner side of the connecting ring is fixedly provided with a mounting strap arranged in a circular distribution, the mounting strap is internally provided with connecting slots distributed in a circular equidistance, the fixed inner ring is internally provided with fasteners arranged in the circular equidistance, the fasteners are slidably connected into the connecting slots, the top cover is internally provided with slots arranged in the circular equidistance, and the slots are engaged with the fasteners;
wherein the connecting ring and the annular sealing ring are made of elastic material, an inner side of the top cover is adhered with the mounting strap to form a whole, and the inner side of top cover is fixedly provided with a transparent film;
wherein the V-shaped grooves are arranged in the circular distribution along the annular sealing ring, and both sides of the V-shaped grooves are respectively clamped inside the fixed inner ring and the top cover to form a sealing structure;
wherein both sides of the connecting ring is fixedly provided with a plurality of pressed blocks equally spaced, the fixed inner ring is internally provided with a plurality of sliding grooves equally spaced, and the pressed blocks corresponds one-to-one with the sliding grooves; and
wherein the sliding grooves are internally provided with embedded buttons for sliding, outer sides of the embedded buttons are clamped with the pressed blocks, and the embedded buttons are in contact with the one side of the mobile phone.

2. The waterproof phone case with easily detachable panel according to claim 1, wherein a top and a bottom of the connecting ring each is provided with a mounting groove, the mounting groove provided on the top of the connecting ring is internally clamped with a sealing plug, and the mounting groove provided on the bottom of the connecting ring is internally clamped with a quick-release plug.

3. The waterproof phone case with easily detachable panel according to claim 2, wherein the quick-release plug is configured as a two-stage structure, and one end of the quick-release plug is connected into the connecting ring and the fixed inner ring.

4. The waterproof phone case with easily detachable panel according to claim 1, wherein a rear side of the fixed inner ring is fixedly provided with a rear cover extending to a rear side of the connecting ring, and the rear cover is fixedly provided internally with four symmetrically distributed suction cups extending into the connecting ring.

5. The waterproof phone case with easily detachable panel according to claim 4, wherein a rear side of the rear cover is provided with a protrusion extending to the rear side of the connecting ring, an interior of the protrusion is provided with the transparent film, and the interior of the protrusion is configured to receive a camera module arranged on a back of the mobile phone.
